(19) United States
(12) Patent Application Publication
(10) Pub. No.: US 2013/0058758 A1
(43) Pub. Date: Mar. 7, 2013

(54) WIND TURBINE INSTALLED ON THE TOP FLOOR OF A RESIDENTIAL BUILDING, PARTICULARLY IN AN URBAN AREA

(71) Applicants: Pierre Lecanu, Esquay Sur Seulles (FR); Eric Quemere, Cormeilles en Parisis (FR)

(72) Inventors: Pierre Lecanu, Esquay Sur Seulles (FR); Eric Quemere, Cormeilles en Parisis (FR)

(21) Appl. No.: 13/517,433

(22) PCT Filed: Dec. 14, 2010
(86) PCT No.: PCT/FR2010/052720

§ 371 Date: Nov. 20, 2012

(30) Foreign Application Priority Data
Dec. 21, 2009 (FR) FR0959278

(51) Int. Cl. F03D 9/00

(52) U.S. Cl. 415/2.1

(57) ABSTRACT

A vertical axis wind turbine installed on the top floor of a residential building, particularly in an urban area, is provided with a rotor fitted with blades and actuated by the wind, thus driving a generator to provide electrical power. The wind turbine includes a wind-channelling base which extends through a funnel, particularly a diverging tapered funnel, at the neck of which the rotor is placed. The rotor includes a median channelling hub mounted on the inner part of the neck of the funnel.

### CROSS-REFERENCE TO RELATED APPLICATIONS

This application is a U.S. National Phase Patent Application based on International Application No. PCT/FR2010/052720 filed Dec. 14, 2010, which is based on French Patent Application No. 0959278 filed Dec. 21, 2009, the entire disclosures of which are hereby explicitly incorporated by reference herein.

### BACKGROUND OF THE INVENTION

1. Field of the Invention

The present invention relates to a wind turbine, particularly having a vertical axis and installed on the top floor of a building, such as a residential building, block, tower or the like, particularly in an urban area, the wind turbine being provided with a rotor fitted with blades actuated by the wind and driving a generator to provide electrical power.

2. Description of the Related Art

For a considerable time, experts in the field have been seeking ways of using wind energy, which has the advantage of being clean, that is to say creating no thermal or chemical pollution, and also inexhaustible.

However, these advantages are largely counterbalanced by a number of drawbacks related, in particular, to the dispersed and intermittent nature of the wind.

It is also well known that wind farms occupy a large amount of space and do not operate without creating noise nuisance.

Because of these drawbacks, the market for wind turbines has not grown in the way that might have been expected.

In recent years, numerous large horizontal axis wind turbines, mounted on very tall masts in order to make use of the greater wind speeds found at higher altitudes, have appeared in the countryside and along coastlines.

These wind turbines, installed in high wind areas where the wind is relatively stable, can usually generate electricity for 30% of the year.

Installing wind turbines in urban areas is much more problematic, since the wind is unstable there, and the only locations really suitable for the installation of wind turbines are high buildings or buildings on favourable sites, such as hilltops.

A wind turbine installed in this way in a favourable location still has low efficiency because of the turbulence created by the building, which forms an obstacle that the wind has to flow round.

Moreover, installing wind turbines in cities leads to problems of safety, aesthetics and noise nuisance which are very difficult to overcome.

As a result, the integration of wind turbines into the urban environment is very limited at present.

In order to overcome this drawback, it has been proposed, as described in FR 2 913 072, that a floor be added to a residential building and dedicated to the installation of a set of wind turbines, while also incorporating services such as the power system for lifts.

A wind turbine installed in this way includes a wind channelling base, which is associated with air intakes located at the periphery of the floor of the building reserved for them, and which extends towards the outside in the form of a funnel, particularly a diverging tapered funnel, at the neck of which the rotor is housed.

This system has the advantage of allowing regions of turbulent flow to be eliminated and increasing the wind capture surface areas.

For this purpose, it has been proposed that the air intakes be fitted with powered shutters for regulating the air flow and channelling it to one or more wind turbines, according to the speed and direction of the wind.

In low wind conditions, the air can thus be channelled towards a single wind turbine, whereas, if the wind speed increases, the captured air can be guided towards a plurality of wind turbines. In this way, the energy recovery is optimized, even when the wind speed is low.

### SUMMARY OF THE INVENTION

The object of the present invention is to propose a wind turbine of the aforementioned type having greater efficiency.

For this purpose, the invention proposes a wind turbine installed on the top floor of a residential building, particularly in an urban area, characterized in that it includes a median channelling hub mounted in the inner part of the funnel neck.

The vanes of the wind turbine can be mainly of the active lift type or mainly of the active drag type.

In a wind turbine of the type considered in the context of the invention, the air speed is greater in the median part of the funnel neck than at the periphery of the funnel neck along the walls.

This speed distribution is unfavourable to the efficiency of the wind turbine, since the structure of the generator is such that the maximum torque must be located at the ends of the blades, and not in the central region.

According to the invention, the inventors have had the idea of overcoming this drawback by preventing any air flow in the median part of the funnel neck by adding a median channelling hub such that the air speed at the periphery of the funnel neck, in other words at the ends of the blades of the wind turbine, can be increased.

This optimization of the air flow around the wind turbine blades can be supplemented by a reduction in the height of the funnel and an increase in its diameter.

In particular, it is advantageous for the funnel to have the shape of a highly flared cone which is extended in the direction of flow of the air by a straight-walled or tapered peripheral ring having a larger diameter, which serves to keep the air flow in the proximity of the walls of the funnel.

According to the invention, the recovery of energy from the wind and therefore the efficiency of the wind turbine can be increased further by optimizing the geometry of the air intakes located at the periphery of the top floor of the building where it is installed, in other words by optimizing the height and width of these air intakes, given that they are usually rectangular in shape.

If the cross section is not rectangular, the geometry of the air intake cross section can be optimized by carrying out an air flow study, by means of numerical calculation or wind tunnel testing.

These air intakes can also be fitted advantageously with air capture elements such as a cowl located in the upper part, or lateral deflectors or air channelling elements located in the lower part.

Since wind speeds are generally lower in urban environments than in the countryside, it is essential, according to the invention, to be able to recover energy from low winds as well as from high winds.

For this purpose, it is advantageous for the rotor of the wind turbine to be associated not with a single generator, but with a set of generators which can be driven selectively according to the wind speed.

Thus, if the wind is low, causing the rotation speed of the blades to be low, the rotor is coupled to a low-power generator, whereas, if the wind speed and the rotation speed of the blades increase, the rotor is coupled to a higher-power generator.

Because of the presence of this set of generators which can be coupled selectively to the rotor, it is possible to recover the energy from the wind progressively over a very large part of the year, thereby increasing the efficiency of the wind turbine according to the invention.

It should be noted that, according to the invention, the generators can be driven directly by the wind turbine rotor, or can be driven through a multiplier system which may or may not be disengageable, depending on how small the inertia of these generators is.

The coupling of the generators to the electrical grid can be controlled in accordance with the wind speed or in accordance with the rotation speed of the rotor.

According to another characteristic of the invention, the median channelling hub is fitted with at least swirl diffuser for air distribution fixed along its outer periphery.

This swirl diffuser or diffusers, which may have a constant or variable pitch, create a uniform air flow in the funnel neck around the blades of the wind turbine, thus increasing the efficiency of the latter.

Another advantage of these swirl diffusers for air distribution is related to the fact that they can be used to optimise the angle of incidence, in other words the inclination of the apparent wind acting on the blades of the rotor, in order to avoid problems related to the so-called phenomenon of “stalling” encountered in wind turbines installed in urban environments because of the instability of the wind.

As experts in this field know, the rotor blades of a wind turbine are subjected to the action of an apparent wind whose speed is equal to the resultant of their tangential speed and the real wind speed.

This apparent wind, which is received at a given angle of incidence, induces a force which can be analysed into a tangential component, or “drag”, and an axial component, or “lift”.

A variation of wind speed results in a variation of the apparent wind and consequently of the angle of incidence.

The profile of a wind turbine blade is determined for a relatively small range of angles of incidence, and, outside this range, the lift and drag become practically zero: this is the phenomenon known as “stalling”, which has little importance in the case of large wind turbines installed in the countryside where winds are relatively stable, but which poses a substantial problem in an urban environment.

This problem can be resolved by creating a reactive thrust induced by the blocking of the fraction of the apparent wind emerging directly from the rotor, which the blades must compensate for by an increase in their speed.

However, in order to optimize this reactive thrust, it is essential for the incoming apparent wind acting on the blades to be inclined.

This inclination can be achieved by the presence of at least one swirl diffuser for air distribution.

For this purpose, it is also possible, according to another characteristic of the invention, to fit the median channelling hub with a set of radial rectifying vanes distributed around this hub.

These rectifying vanes can advantageously interact with at least one swirl diffuser for air distribution and be located downstream of this swirl diffuser in the direction of flow of the wind.

In a first variant of the invention, the median channelling hub is formed by an essentially cylindrical element.

In a second variant of the invention, the wind channelling base is formed by a wind channelling tube which encloses in its inner part a coaxial rotating tube on which the blades are fixed, and which is fitted with a diaphragm creating a constricted cross section and forming the median channelling hub.

This constriction creates a pressure drop and consequently an acceleration of the air at the rotor blades such that the efficiency of the wind turbine is improved.

In a third variant of the invention, the wind channelling base is formed by a wind channelling tube which encloses in its inner part a diverging/converging ovoid hub mounted coaxially, forming the median channelling hub and including, in the direction of flow of the wind, a diverging part or stator which is extended by a converging rotating part or rotor on which the blades are fixed.

This ovoid hub formed by a stator and a rotor enables the cross section of the air flow to be constricted progressively, causing an increase in the speed of the flow.

Furthermore, this constriction forces the flowing air to approach the channelling tube, thus enabling the best use to be made of the useful radius of the rotor blades.

According to another characteristic of this third variant of the invention, the stator is fitted with radial rectifying vanes.

According to another characteristic of this third variant of the invention, the wind channelling tube encloses in its inner part a coaxial rotating tube which surrounds the stator and on which a second set of blades is fixed.

According to this characteristic, the wind turbine is fitted with a double vaned rotor, composed of an inner rotor on the one hand, and an outer rotor, formed by a conventional wind turbine, on the other hand.

It should be noted that the blades fitted on the rotor(s) of the wind turbine according to the invention can be of any type (aerofoil profile, vane, or other) and can be combined with one or more swirl diffusers for air distribution and/or radial rectifying vanes.

### BRIEF DESCRIPTION OF THE DRAWINGS

The features of the wind turbine proposed by the invention will now be described more fully with reference to the appended non-limiting drawings, in which:

FIG. 1 is a schematic perspective view of the top floor of a residential building, this floor being dedicated to the installation of a set of wind turbines, according to the prior art;

FIG. 2 is a partially sectional perspective view of a wind turbine according to the first variant of the invention, installed on the top floor of a residential building of the above type;

FIG. 3 is a perspective view of the median channelling hub of a wind turbine according to the first embodiment of the invention, fitted with a swirl differ for shaping the air flow and a set of radial rectifying vanes;

FIG. 4 is a perspective view of a wind turbine according to the second variant of the invention;

FIG. 4a is a diagram illustrating the configuration of the wind turbine shown in FIG. 4;

FIG. 5 is a partially sectional perspective view of a wind turbine corresponding to a first embodiment of the third variant of the invention;

FIG. 5a is a diagram illustrating the configuration of the wind turbine shown in FIG. 5;

FIG. 6 is a perspective view of a wind turbine corresponding to a second embodiment of the third variant of the invention; and

FIG. 6a is a diagram illustrating the configuration of the wind turbine shown in FIG. 6.

### DETAILED DESCRIPTION

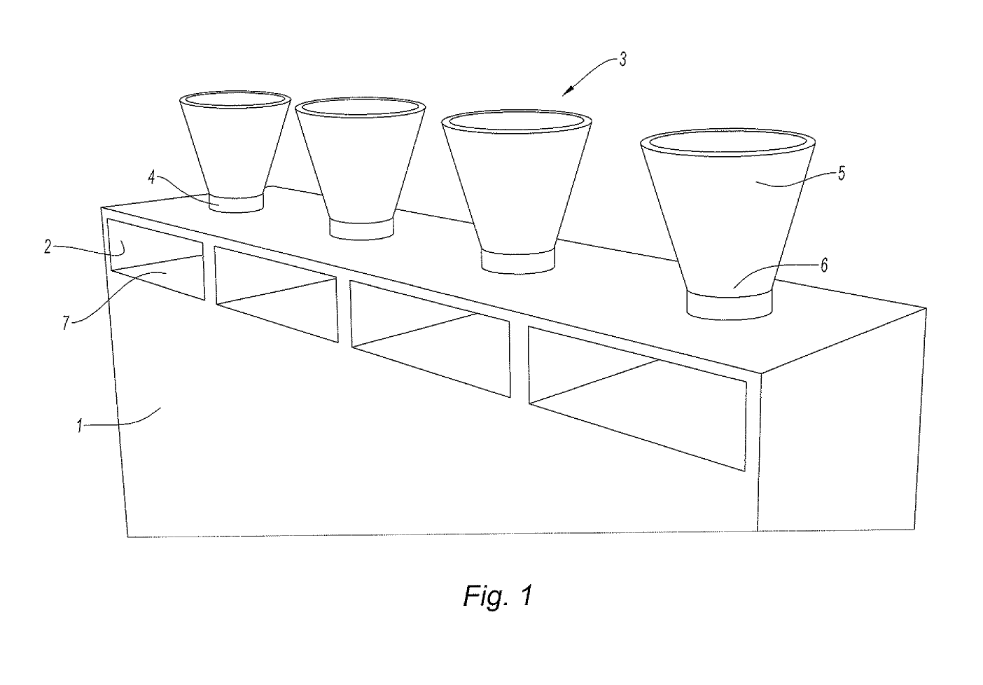

In FIG. 1, a top floor 2 has been added to a residential building 1 which is shown schematically.

This top floor 2 is dedicated to the installation of a set of wind turbines 3, there being four wind turbines in the example shown in FIG. 1.

Each of these wind turbines includes a wind flow base 4 which is extended by a diverging tapered funnel 5.

A rotor fitted with a set of blades, not visible in FIG. 1, is housed in the inner part of the neck 6 of the funnel 5.

The channelling base 4 of each of the wind turbines 3 is associated with air intakes 7 located at the periphery of the top floor 2 of the building 1.

These air intakes 7 are rectangular in shape and have a geometry, and in particular a width and height, adapted to achieve maximum wind capture, and are fitted with air capture elements not shown in FIG. 1.

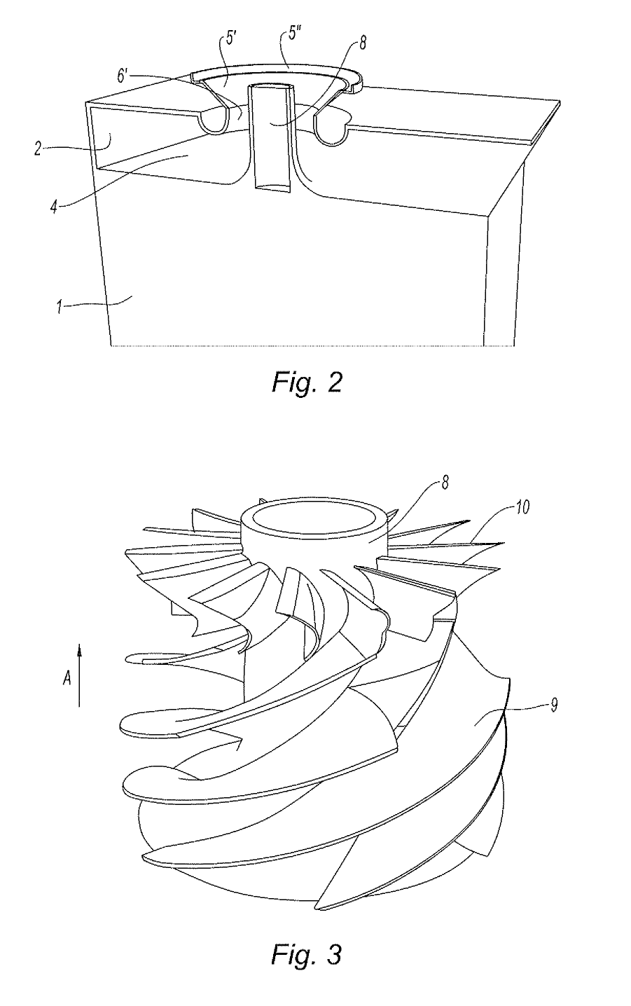

In FIG. 2, a median channelling hub 8 is mounted in the inner part of the neck 6′ of the funnel 5′ at the location where the rotor of the wind turbine, which is not shown, is housed.

This channelling hub 8, which is formed by an essentially cylindrical element, enables any air flow in the median part of the neck 6′ of the funnel 5′ to be prevented.

As shown in FIG. 2, the funnel 5′ takes the form of a highly flared cone having a smaller height and a larger diameter than the wind turbine 5 shown in FIG. 1.

Additionally, this cone 5′ is extended in its outer part by a peripheral ring of larger diameter 5″, which serves to keep the air flow in the proximity of the walls of the funnel 5′.

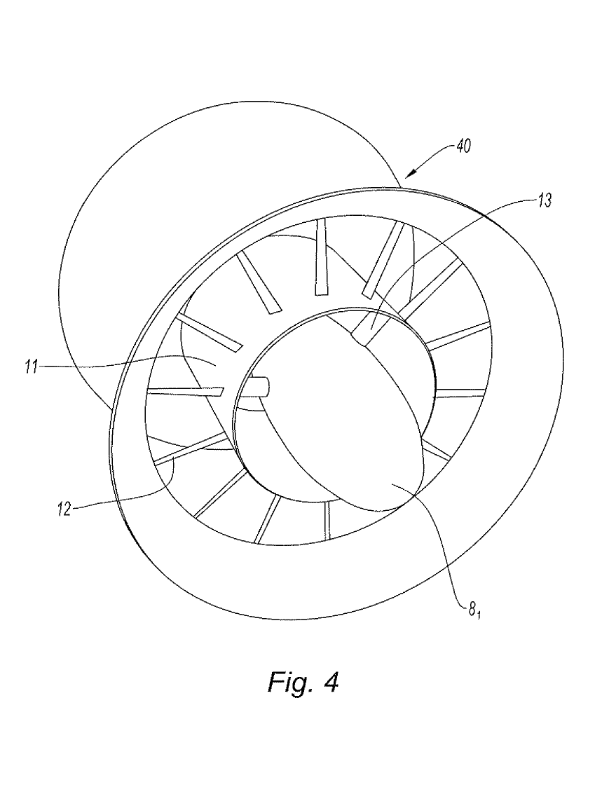

As shown in FIG. 3, the median channelling hub 8 is fitted with a swirl diffuser for air distribution 9 fixed along its outer periphery.

This swirl diffuser for air distribution 9 is extended by a set of radial rectifying vanes 10 which are distributed around the median channelling hub 8, downstream of the swirl diffuser 9 in the direction of flow of the wind, which is shown schematically by the arrow A.

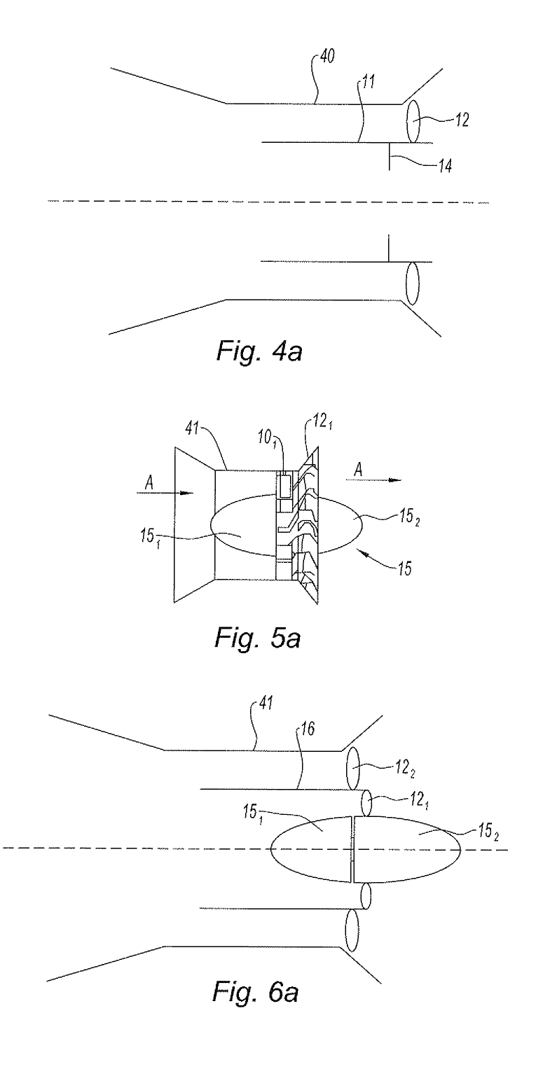

As shown in FIGS. 4 and 4a, the wind channelling base is formed by a wind channelling tube 40 which encloses in its inner part a coaxial rotating tube 11 on which the blades 12 are fixed.

As shown in FIG. 4, the coaxial rotating tube 11 is fitted with a median diaphragm of ovoid shape 8₁ which is fixed to the tube by means of struts 13 and forms the median channelling hub.

As shown in FIG. 4a, the rotating tube 11 is fitted on its inner periphery with an annular diaphragm 14 which again forms the median channelling hub.

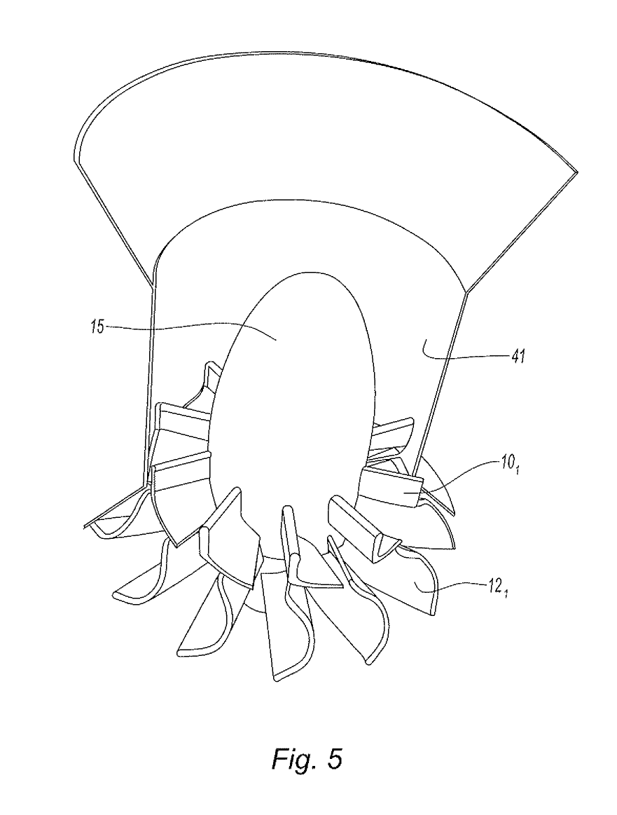

As shown in FIGS. 5 and 5a, the wind channelling base is formed by a wind channelling tube 41 which encloses in its inner part a coaxially mounted converging/diverging ovoid hub 15 which forms the median channelling hub.

This ovoid hub 15 includes, in the direction of flow of the wind represented by the arrows A, a diverging fixed part 15₁ or stator which is extended by a converging rotating part 15₂ or rotor to which the blades 12₁ are fixed.

The stator 15₁ is fitted with radial rectifying vanes 10₁.

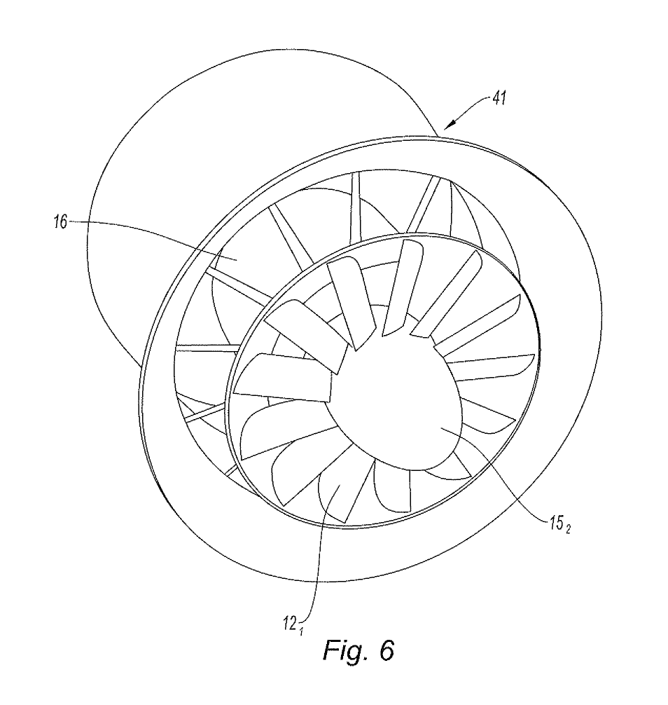

In FIGS. 6 and 6a, the wind channelling tube 41 encloses in its inner part a coaxial rotating tube 16, which surrounds the stator 15₁, and to which a second set of blades 12₂ is fixed.

The wind turbine shown in FIGS. 6 and 6a is thus fitted with a double bladed rotor, in other words an inner rotor similar to that shown in FIGS. 5 and 5a and an outer rotor similar to that of a conventional wind turbine.

### LEGEND

1 Residential building
2 Top floor
3 Wind turbines
4 Channelling base
5, 5′ Funnel
5″ Peripheral ring
6,6′ Neck of the funnel
7 Air intakes
8 Median channelling hub
8₁ Median diaphragm
9 Swirl diffuser for air distribution
10, 10₁ Rectifying vanes
11 Rotating tube
12, 12₁, 12₂ Blades
14 Annular diaphragm
15 Ovoid hub
15₁ Stator
15₂ Rotor
16 Coaxial rotating tube
40, 41 Wind channelling tube

1-9. (canceled)

10. A wind turbine for use on a top floor of a building, said wind turbine comprising:
a rotor rotatable about a vertical axis and including a plurality of blades actuable by wind to drive a generator for providing electrical power; and
a wind channelling base disposed beneath said rotor and in flow communication with a diverging tapered funnel, said rotor disposed at a neck of said funnel, said funnel further including a median channelling hub mounted on an inner part of said neck of said funnel.

11. The wind turbine of claim 10, wherein said median channelling hub includes at least one swirl diffuser fixed along an outer periphery thereof for air distribution.

12. The wind turbine of claim 10, wherein said median channelling hub includes a set of radial rectifying vanes distributed around said hub.

13. The wind turbine of claim 12, wherein said radial rectifying vanes interact with at least one swirl diffuser for air distribution and are located downstream of said swirl diffuser in a direction of wind flow.

14. The wind turbine of claim 10, wherein said median channelling hub comprises a substantially cylindrical element.

15. The wind turbine of claim 10, wherein said wind channelling base is formed by a wind channelling tube which encloses in its inner part a coaxial rotating tube to which said blades are fixed, said tube including a diaphragm creating a constricted cross section and forming said median channelling hub.

16. The wind turbine of claim 10, wherein said wind channelling base is formed by a wind channelling tube which encloses in its inner part a diverging/converging ovoid hub mounted coaxially, said hub forming said median channelling hub and including, in a wind flow direction, a diverging stator which is extended by a converging rotating rotor to which said blades are fixed.

17. The wind turbine of claim 16, wherein said stator includes radial rectifying vanes.

18. The wind turbine of claim 16, wherein said wind channelling tube encloses in its inner part a coaxial rotating tube surrounding said stator and to which a second set of blades is fixed.
